(19) United States
(12) Patent Application Publication
(10) Pub. No.: US 2002/0122356 A1
(43) Pub. Date: Sep. 5, 2002

(54) Emergency run response timer

(76) Inventor: David Bourdeu, Carriere, MS (US)

Correspondence Address: David Bourdeu, 21 Fred Johnson Road, Carriere, MS, 39426, US

(21) Appl. No.: 09/861,582

(22) Filed: Apr. 15, 2002

Related U.S. Application Data
(63) Continuation of application No. 60/212,733, filed on Jun. 20, 2000.

(51) Int. Cl. G04C 1/00

(52) U.S. Cl. 368/327

(57) ABSTRACT

The device consists of a basic 24-pin stamp processor. Pin #1 TX Serial output. Pin #2 RX Serial input. Pin #3 ATN Active-high reset. Pin #4 GND Serial ground. Once powered up a normally open switch is pressed sending data to pin #5 and #6 I/O pin #0 and I/O #1. This sets the time in the 24-pin basic stamp processor. To activate the in route time a normally open switch is pressed sending data to pin #9 I/O pin #4 which stores this data in the processor. Upon arriving on the scene a normally open switch is pressed sending data to pin #10 I/O pin #5 which stores this data in the processor. Upon leaving the scene a normally open switch is pressed sending data to pin #11 I/O pin #6, which stores this data in the processor. Upon back in service a normally open switch is pressed sending data to pin #12 I/O pin #7, which stores the data in the processor. To recall stored processor data a normally open switch is pressed sending data to pin # 7 and #8 I/O pin #2 and #3. Each normally open switch when pressed causes data to go to pin #16 and #17 I/O pin #11 and I/O pin #12, which causes a buzzer to sound. The LCD 2×16 serial LCD is tied into GND +5V DC and pin #16. All switches are powered +5V parallel 10-ohm resistors with the LCD; buzzer and the basic stamp +9V. Pin #21 +5V input or regulated output. Pin #22 RES Active-low reset. Pin #23 GND System ground. Pin #24 PWR Regulators input. Each pin of the stamp can source 20 ma and sink 25 ma.

The Emergency Run Response Timer is a microprocessor based device that emergency services personnel can use to accurately log the address and response times to emergency calls. It gives the user the ability to accurately record the response times of up to five emergency runs that can be recalled and displayed at any time to be documented or erased. Emergency Service agencies such as fire, rescue and paramedics are required to record the following 4 response times:

1.) In-Route—The time that the call is dispatched.

2.) On-Scene—The time of arrival at the address or location of emergency.

3.) Leave-Scene—The time of departure from the location of the emergency.

4.) In-Service—The time of completion of emergency run.

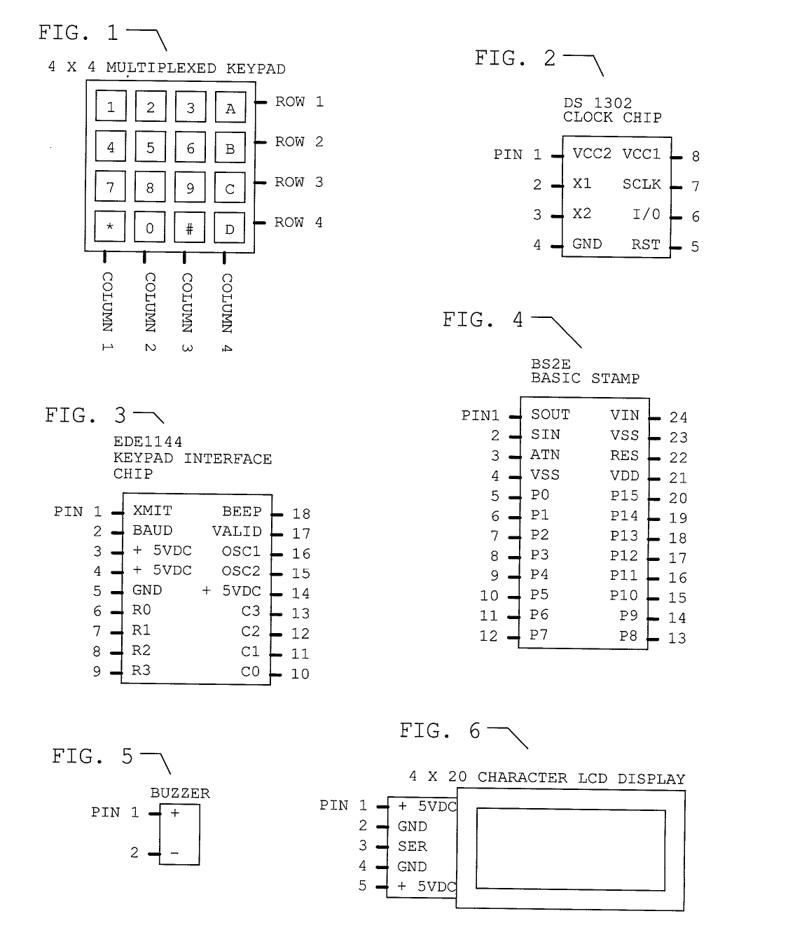

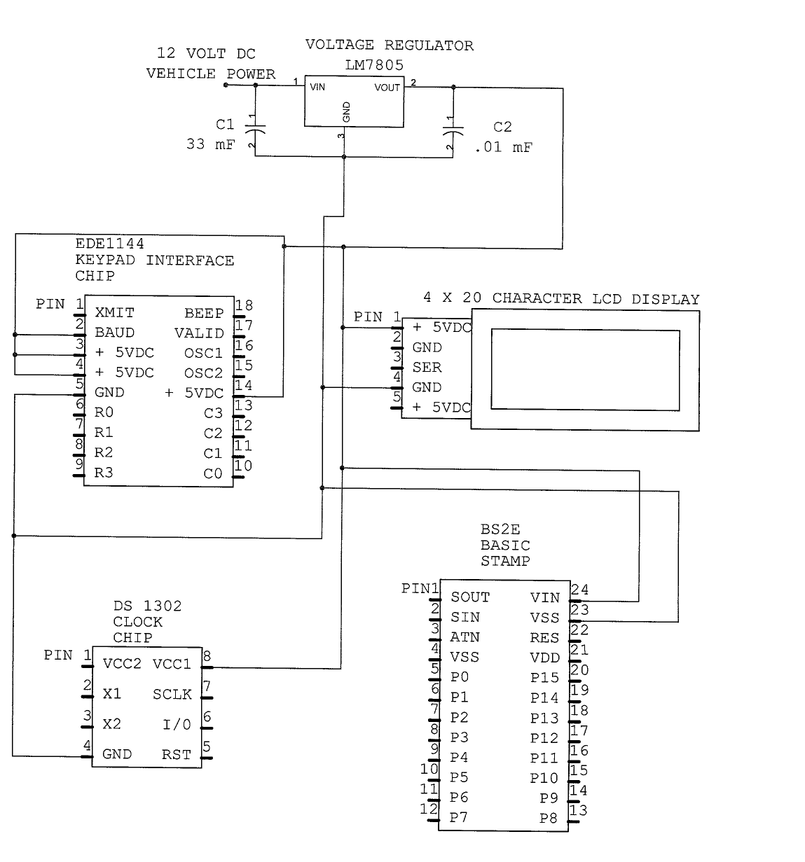

Drawing sheets 1/4 and 2/4 illustrate FIGS. 1 through 6E. Upon being dispatched to an emergency, the user enters the address or location of emergency and presses the letter A on the keypad (FIG. 1). An audible tone from the buzzer (FIG. 5) to let the user know that the time has been logged will be heard. The address and the In-Route time will be displayed on the liquid crystal display (FIG. 6a) for 10 seconds. After 10 seconds, the liquid crystal display (FIG. 6b) will only display the address or location of the emergency. Upon arriving at the location of the emergency, the user will again press the letter A on the keypad (FIG. 1). An audible tone from the buzzer (FIG. 5) indicating a successful time log will be heard and the liquid crystal display (FIG. 6c) will now display the address of the emergency, the In-Route time, and the On-Scene time. Upon departing from the emergency, the user will again press the letter A on the keypad (FIG. 1). An audible tone from the buzzer (FIG. 5) indicating a successful time log will be heard and the liquid crystal display (FIG. 6d) will now display the address of the emergency, the In-Route time, the On-Scene time, and the Leave-Scene time. After completion of the emergency ran, the user will again press the letter A on the keypad (FIG. 1). An audible tone from the buzzer (FIG. 5) will be heard and the liquid crystal display (FIG. 6e) will now display the address, the In-Route time, the On-Scene time, the Leave-Scene time, and the In-Service time. The user has the option of documenting the run times and deleting the data by pressing the letter C followed by the # key on the keypad (FIG. 1) or continuing on to a second emergency and starting the process over again. If multiple runs are made, the user can recall and display each run one at a time by pressing the letter D followed by the # key on the keypad (FIG. 1)

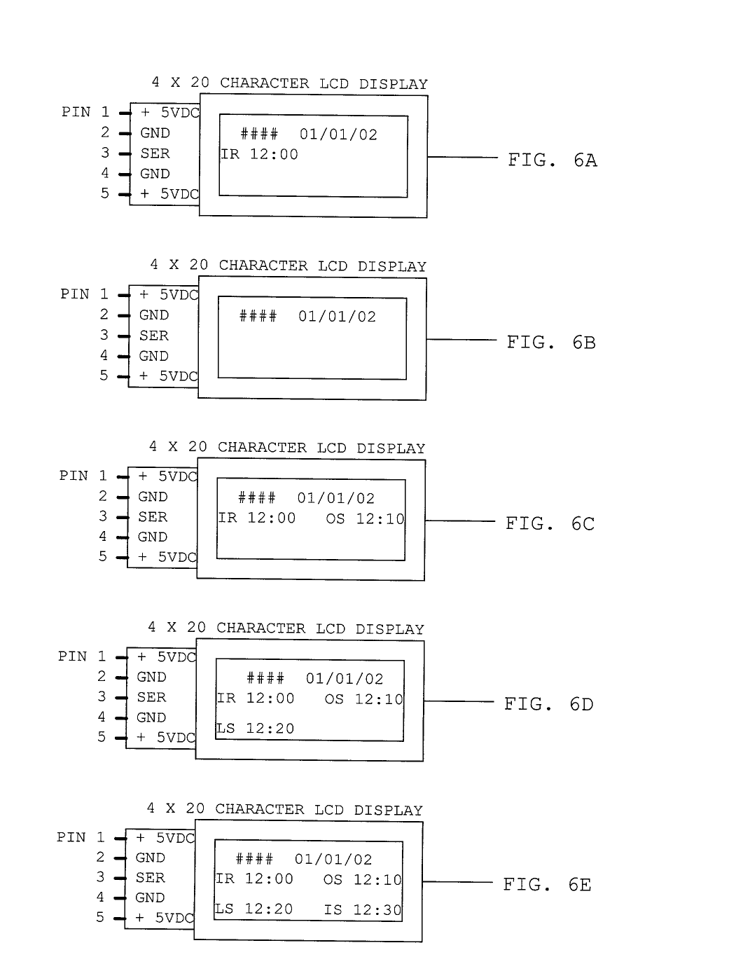

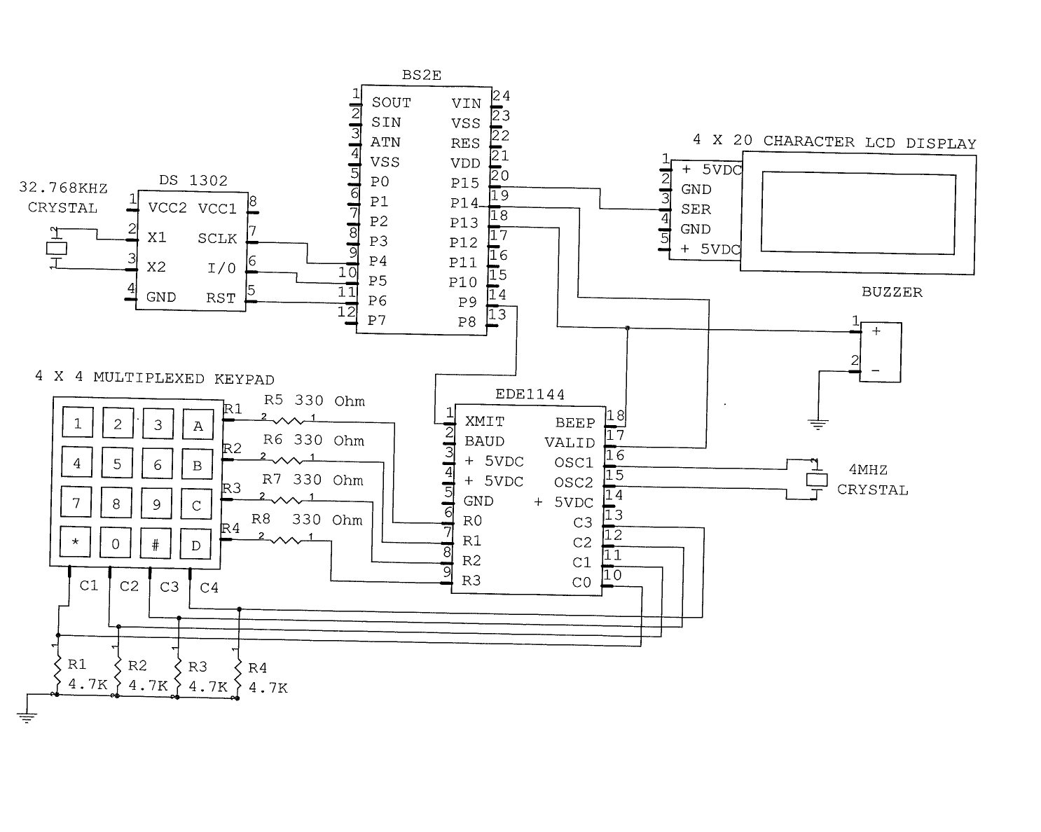

The Emergency Run Response Timer's BS2E microprocessor (FIG. 4) uses serial communications to send and receive data to and from the real-time clock chip (FIG. 2), the liquid crystal display (FIG. 6), and the multiplexed keypad interface chip (FIG. 3). The communications connections are illustrated on drawing sheet 3/4. When a button on the multiplexed keypad (FIG. 1) is pressed, the interface face chip EDE1144 (FIG. 3) interprets the data to see if it's valid. If the data is valid, pin 17 of the EDE1144 (FIG. 3), goes high and pin 18 sends a signal to the buzzer (FIG. 5). The BS2E microprocessor (FIG. 4) pin 14 is set as an input looking at the EDE1144 (FIG. 3) pin 17 VALID line. When the EDE1144 interface chip (FIG. 3) pin 17 goes high, the BS2E microprocessor (FIG. 4) is instructed through software to receive serial data on pin 13 from the EDE1144 interface (FIG. 3) pin 1. If the Emergency Run Response Timer is in use, the BS2E microprocessor (FIG. 4) is instructed through software to store the data received along with a text string into system memory. The BS2E microprocessor (FIG. 4) will store up to 5 emergency calls into system memory and allows the user to recall all of the data to the liquid crystal display (FIG. 6) to be documented or erased from memory. The BS2E microprocessor (FIG. 4) communicates to the DS1302 clock chip (FIG. 2), on a serial three-wire connection consisting of a serial clock (SCLK) for data input, input/output line (I/O), for connection to the clock input, and reset (RST) for turning on control logic which accesses the shift register and provides a method of terminating either single byte or multiple byte data transfer. When power is first applied to the system, the BS2E microprocessor is instructed through software to make a temporary connection to the DS1302 clock chip (FIG. 2) to establish the time, once established the DS1302 clock chip (FIG. 2) updates the BS2E microprocessor (FIG. 4) once a second. The BS2E microprocessor (FIG. 4) takes the all of the data received from both the EDE1144 interface chip (FIG. 3) and the DS1302 clock chip (FIG. 2) and transmits it serially to the LCD display (FIG. 6). The liquid crystal display (FIG. 6) will display the current date, month, year, and the current time of day in 24 hr. format when the “Emergency Run Response Timer” is not in use.

Power for the “Emergency Run Response Timer” as illustrated in drawing sheet 4/4 is taken from the vehicle in which the unit is placed. The “Emergency Run Response Timer” provides it's own voltage regulation that will step down the incoming 12 volts DC into a useable 5 volts DC signal that feeds the BS2E microprocessor (FIG. 4), the DS1302 clock chip (FIG. 2), and the EDE1144 keypad interface chip (FIG. 3).

The “Emergency Run Response Timer” can be packaged in a suitable enclosure to meet the customer's needs, as vehicle equipment racks tend to vary in size. Since space limitations exist in emergency vehicles, the “Emergency Run Response Timer” can be custom built to suit the needs of the customer.

What I claim as my invention is:

1. A time storing device that will be used in Fire, EMS, Rescue, and Volunteer Firefighter Agencies. The time keeping of emergency responses at the present time is poor at best. My invention will allow the vehicle operator to store his or her own run times, which will be extremely accurate. All times will be stored and available at the simple press of a button. My invention will erase the problem of not having accurate times to put in the official run report.
